(19) United States
(12) Patent Application Publication
(10) Pub. No.: US 2025/0387793 A1
(43) Pub. Date: Dec. 25, 2025

(54) RADIAL LOCKING SYSTEM FOR ATTACHING A ROTOR

(71) Applicant: FIBERLITE CENTRIFUGE LLC, Santa Clara, CA (US)

(72) Inventor: Sina PIRAMOON, Santa Clara, CA (US)

(21) Appl. No.: 18/879,525

(22) PCT Filed: Jun. 27, 2023
(86) PCT No.: PCT/US2023/026382

§ 371 Date: Dec. 27, 2024

Related U.S. Application Data
(60) Provisional application No. 63/356,117, filed on Jun. 28, 2022.

(51) Int. Cl. B04B 9/08

(52) U.S. Cl. CPC B04B 9/08; B04B 2009/085

(57) ABSTRACT

A drive head (20) of a centrifuge drive for detachably connecting a rotor to the centrifuge. The drive head includes a drive head hub (74) having a plurality of recesses (98) spaced circumferentially and symmetrically about the drive head hub, a locking shoe (80) movably retained within each of the plurality of recesses and movable radially therein, and a resilient element (102) located between each locking shoe and the drive head hub for biasing each locking shoe in a radially outward direction relative to the rotational axis of the centrifuge drive. Each locking shoe is configured to exert a radially outwardly directed force on an interior sidewall of the hub of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

### TECHNICAL FIELD

This invention relates generally to centrifuges and, more particularly, to a drive head locking system of a centrifuge drive for detachably connecting a rotor to the centrifuge.

### BACKGROUND

Laboratory centrifuges generally include a rotor removably coupled to a drive for rotating the rotor at a particular speed required for the centrifuging of samples stored in the rotor. While centrifuge rotors may vary significantly in construction and in size, common rotor structures are a fixed-angle rotor and a swinging-bucket rotor (also referred to as a swing-out rotor) each of which have a solid rotor body with a plurality of receiving chambers, or rotor wells, distributed radially within the rotor body and arranged symmetrically about an axis of rotation of the rotor. Samples in sample containers of appropriate size are placed in the plurality of rotor wells, allowing a plurality of samples to be subjected to centrifugation when the rotor is rotated by the centrifuge drive.

To cause the rotor to rotate at a particular speed, the rotor is removably attached to a drive shaft, or spindle, of the centrifuge that is driven by a motor. In this regard, the centrifuge spindle typically includes a locking system configured to be received by the rotor for both securing the rotor to the centrifuge drive and transmitting torque between the drive and the rotor for rotation of the rotor at a particular speed. One type of conventional locking system is one that is operated by centrifugal force. That is, with increasing rotational speed of the rotor, the coupling force exerted by the coupling device on the rotor increases. However, these conventional types of locking systems often require the use of tools to initially couple and to decouple the rotor and the centrifuge drive. Other conventional locking system designs include an integrated actuator or push button operable to initially couple and to decouple the rotor and the centrifuge drive, for example. To this end, the use of tools or other mechanisms to mechanically couple the rotor to the centrifuge drive is a result of the limited performance capabilities of centrifugally operated locking systems, being limited by their ability to accommodate torque and the associated axial forces caused by centrifugal forces during rotation of the centrifuge rotor by the centrifuge drive, particularly at high rotational speeds.

Therefore, a need exists to provide a centrifuge which ensures reliable locking against both rotational forces and axial lifting forces acting against the centrifuge rotor during a range of rotational speeds, but particularly at high rotational speeds, with the locking force increasing with the rising rotational speed of the centrifuge rotor. Furthermore, the rotor should be able to be mountable to and dismountable from the centrifuge drive in a very short period of time and without the use of tools, pushbuttons, or other mechanical actuators, for example.

### SUMMARY

The present invention overcomes the foregoing and other shortcomings and drawbacks of centrifuge drive head locking systems for detachably connecting a rotor to the centrifuge drive. While the present invention will be discussed in connection with certain embodiments, it will be understood that the present invention is not limited to the specific embodiments described herein.

According to one embodiment of the invention, a drive head for a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The hub of the centrifuge rotor includes at least one drive pin for transferring rotational movement of the centrifuge drive to the centrifuge rotor. The drive head includes a drive head hub including a central bore configured to receive a fastener therethrough to couple the drive head to a spindle of the centrifuge drive. The drive head hub includes a plurality of recesses formed in an outer sidewall of the drive head hub and spaced circumferentially and symmetrically about the drive head hub, a locking shoe movably retained within each of the plurality of recesses and movable therein in a radially inward direction and a radially outward direction relative to the rotational axis of the centrifuge drive, and a resilient element located between each locking shoe and the drive head hub for biasing each locking shoe in the radially outward direction relative to the rotational axis of the centrifuge drive. Each locking shoe is configured to exert a radially outwardly directed force on an interior sidewall of the hub of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

According to one aspect of the invention, the drive head includes a crown attached to a top of the drive head hub. The crown includes a central bore configured to receive the fastener therethrough and a plurality of torque slots formed in a top surface of the crown that are configured to receive the at least one drive pin of the hub of the centrifuge rotor therein to transfer rotational movement of the centrifuge drive to the centrifuge rotor. The drive head also includes a retaining plate attached to a base of the drive head hub. The retaining plate includes a central bore configured to receive a distal end of the spindle therethrough.

According to another aspect of the invention, each locking shoe includes a curved outer surface in transverse cross-section that matches a curvature of the interior sidewall of the hub of the centrifuge rotor in transverse cross-section. According to one aspect, each locking shoe includes a chamfered surface that extends between the curved outer surface and a top surface of each locking shoe to facilitate insertion of the drive head into the hub of the centrifuge rotor.

According to yet another aspect of the invention, each locking shoe is movable between a first position wherein each locking shoe is received within a corresponding one of the plurality of recesses in a radially inward direction relative to the rotational axis of the centrifuge drive to define a first outer diameter of the drive head hub, and a second position wherein each locking shoe projects a distance from the corresponding one of the plurality of recesses in a radially outward direction relative to the rotational axis of the centrifuge drive to define a second outer diameter of the drive head hub that is greater than the first outer diameter.

According to one aspect of the invention, the plurality of recesses are spaced equidistantly apart about a circumference of the drive head hub to provide self-centering of the drive head within the centrifuge rotor hub by each locking shoe. According to another aspect, each locking shoe slideably engages a base surface of the crown and a top surface of the retaining plate. According to yet another aspect, each locking shoe includes a pair of shoulders configured to engage with abutment surfaces of each recess to prevent over-extension of the locking shoe from each recess by the resilient element.

According to one aspect, the drive head hub includes a boss that projects upwardly from a top surface of the drive head hub, the boss configured to be received within a pocket formed in a base of the crown for coupling the drive head hub to the crown. According to another aspect, the fit between the boss of the drive head hub and the pocket of the crown is an interference fit.

According to yet another aspect of the invention, each torque slot is an arc-shaped blind bore. According to another aspect, the plurality of torque slots are spaced apart circumferentially about the central bore of the crown. According to one aspect, a first drive pin of the hub of the centrifuge rotor is configured to engage a sidewall of a first torque slot to prevent rotation of the drive head relative to the centrifuge rotor during acceleration of the centrifuge rotor by the centrifuge drive. According to another aspect, a second drive pin of the hub of the centrifuge rotor is configured to engage a sidewall of a second torque slot to prevent rotation of the drive head relative to the centrifuge rotor during deceleration of the centrifuge rotor by the centrifuge drive.

According to one aspect of the invention, a centrifuge is provided with the drive head and includes a centrifuge rotor having a hub configured to receive the drive head therein, the hub including at least one drive pin that projects from an interior surface of the hub in an axially downward direction relative to the rotational axis of the centrifuge drive, the at least one drive pin configured to transfer rotational movement of the centrifuge drive to the centrifuge rotor.

According to another embodiment of the invention, a drive head for a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The hub of the centrifuge rotor includes at least one torque slot formed therein. The drive head includes a drive head hub including a central bore configured to receive a fastener therethrough to couple the drive head to a spindle of the centrifuge drive. The drive head hub includes a plurality of recesses formed in an outer sidewall of the drive head hub and spaced circumferentially and symmetrically about the drive head hub, a locking shoe movably retained within each of the plurality of recesses and movable therein in a radially inward direction and a radially outward direction relative to the rotational axis of the centrifuge drive, a resilient element located between each locking shoe and the drive head hub for biasing each locking shoe in the radially outward direction relative to the rotational axis of the centrifuge drive, and a crown attached to a top of the drive head hub, the crown including a central bore configured to receive the fastener therethrough and at least one drive pin configured to engage the at least one torque slot formed in the hub of the centrifuge rotor to transfer rotational movement of the centrifuge drive to the centrifuge rotor. Each locking shoe is configured to exert a radially outwardly directed force on an interior sidewall of the hub of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

According to one aspect of the invention, the drive head includes a retaining plate attached to a base of the drive head hub, the retaining plate including a central bore configured to receive a distal end of the spindle therethrough.

According to another aspect of the invention, each locking shoe includes a curved outer surface in transverse cross-section that matches a curvature of the interior sidewall of the hub of the centrifuge rotor in transverse cross-section. According to yet another aspect, each locking shoe includes a chamfered surface that extends between the curved outer surface and a top surface of each locking shoe to facilitate insertion of the drive head into the hub of the centrifuge rotor. According to yet another aspect, each locking shoe is movable between a first position wherein each locking shoe is received within a corresponding one of the plurality of recesses in a radially inward direction relative to the rotational axis of the centrifuge drive to define a first outer diameter of the drive head hub, and a second position wherein each locking shoe projects a distance from the corresponding one of the plurality of recesses in a radially outward direction relative to the rotational axis of the centrifuge drive to define a second outer diameter of the drive head hub that is greater than the first outer diameter.

According to one aspect, the plurality of recesses are spaced equidistantly apart about a circumference of the drive head hub to provide self-centering of the drive head within the hub of the centrifuge rotor by each locking shoe. According to another aspect, each locking shoe slideably engages a base surface of the crown and a top surface of the retaining plate. According to yet another aspect, each locking shoe includes a pair of shoulders configured to engage with abutment surfaces of a corresponding one of the plurality of recesses to prevent over-extension of the locking shoe the corresponding one of the plurality of recesses. According to one aspect, the at least one drive pin comprises a first, second, and third drive pin spaced apart circumferentially about the central bore of the crown.

According to another aspect of the invention, a centrifuge including the drive head is provided. The centrifuge includes a centrifuge rotor having a hub configured to receive the drive head therein. The hub includes at least one torque slot formed therein that is configured to receive the at least one drive pin of the crown for transferring rotational movement of the centrifuge drive to the centrifuge rotor. According to one aspect, each torque slot is an arc-shaped blind bore. According to another aspect, the at least one torque slot comprises four torque slots spaced apart circumferentially about a central bore formed in the hub.

According to yet another aspect of the invention, a first drive pin of the crown is configured to engage a sidewall of a first torque slot to prevent rotation of the drive head relative to the centrifuge rotor during acceleration of the centrifuge rotor by the centrifuge drive. According to one aspect, a second drive pin of the crown of the centrifuge rotor is configured to engage a sidewall of a second torque slot to prevent rotation of the drive head relative to the centrifuge rotor during deceleration of the centrifuge rotor by the centrifuge drive.

According to another embodiment of the invention, an adapter for mounting a drive head to a spindle of a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The drive head includes a central bore configured to receive a fastener therethrough to couple the drive head to a distal end of the spindle of the centrifuge drive. The adapter includes a first projection configured to be received within a pocket formed in the drive head, a second projection that projects in an axially opposite direction from the first projection, and a mounting bore that extends axially through the adapter and between a first opening to the mounting bore formed in the first projection of the adapter and a second opening to the mounting formed in the second projection of the adapter. The mounting bore is configured to receive the distal end of the spindle through the second opening such that the central bore of the drive head, the mounting bore, and a threaded bore in the distal end of the spindle are coaxially arranged to receive the fastener therethrough to couple the drive head and the adapter to the distal end of the spindle of the centrifuge drive.

According to one aspect of the invention, the adapter includes a cupped flange located axially between the first projection and the second projection. According to another aspect, the first projection is frustoconical in shape. According to yet another aspect, the mounting bore is frustoconical in shape.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a cross-sectional view of a centrifuge, illustrating a centrifuge rotor coupled to a drive head of a centrifuge drive in accordance with a first embodiment of the invention.

FIG. 2 is an enlarged partial cross-sectional view of the centrifuge of FIG. 1, illustrating the drive head being received within a hub of the centrifuge rotor.

FIG. 2A is an enlarged view of the centrifuge of FIGS. 1-2, illustrating the engagement between an annular lip of the hub of the centrifuge rotor and a surface of a locking shoe.

FIG. 3 is a cross-sectional view similar to FIG. 2, illustrating the centrifuge rotor coupled to the drive head.

FIG. 3A is an enlarged view of the centrifuge of FIGS. 1-3, illustrating the engagement between a base of the locking shoe and the annular lip of the hub of the centrifuge rotor.

FIG. 4 is a sectional view taken along line 4-4 in FIG. 3, illustrating forces acting on locking shoes of the drive head when the drive head is stationary.

FIG. 5 is a view similar to FIG. 4, illustrating forces acting on locking shoes of the drive head when the drive head is rotating the centrifuge rotor at a particular speed.

FIG. 6 is a sectional view taken along line 6-6 in FIG. 3, illustrating a position of drive pins relative to corresponding torque slots in the drive head when the drive head is rotating the centrifuge rotor at a particular speed in a counterclockwise direction.

FIG. 7 is a view similar to FIG. 6, illustrating a position of drive pins relative to corresponding torque slots in the drive head when the drive head is decelerating to a stop.

FIG. 8 is an exploded disassembled view of the drive head of FIGS. 1-8.

FIG. 9 is a cross-sectional view of a centrifuge, illustrating a centrifuge rotor coupled to a drive head of a centrifuge drive in accordance with a second embodiment of the invention.

FIG. 10 is an enlarged cross-sectional view of the centrifuge of FIG. 9, illustrating the drive head received within a hub of the centrifuge rotor.

FIG. 11 is a sectional view taken along line 11-11 in FIG. 10, illustrating a position of drive pins relative to corresponding torque slots in a hub of the centrifuge rotor when the drive head is rotating the centrifuge rotor at a particular speed in a counter clockwise direction.

FIG. 12 is a view similar to FIG. 11, illustrating a position of drive pins relative to corresponding torque slots in the hub of the centrifuge rotor when the drive head is decelerating to a stop.

FIG. 13 is a cross-sectional view of a drive head attached to a spindle of a centrifuge with an adapter in accordance with an embodiment of the invention.

FIG. 14 is a diagrammatic view showing a centrifuge rotor installed in an exemplary centrifuge.

### DETAILED DESCRIPTION

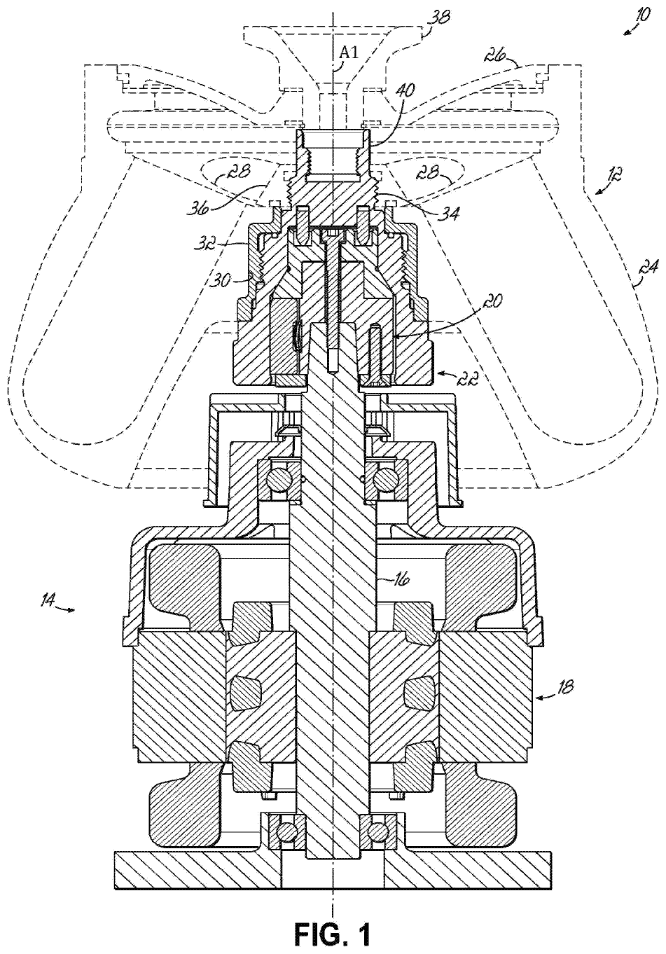

Referring now to the figures, and in particular to FIG. 1, an exemplary centrifuge 10 in accordance with a first embodiment of the present invention is shown without any substructure of the centrifuge 10. As shown in FIG. 1, the centrifuge 10 includes a centrifuge rotor 12 operatively coupled to a centrifuge drive 14 having a drive shaft, or spindle 16, driven by a motor 18 for rotating the rotor 12 about a rotational axis A1 to achieve high-speed, centrifugal rotation of the rotor 12. As shown, the centrifuge drive 14 includes a drive head 20 positioned at one end of the spindle 16 that is configured to be received within a hub 22 of the rotor 12 for detachably connecting the rotor 12 to the centrifuge drive 14 in a tool-less manner, as will be described in further detail below. The connection between the drive head 20 and the rotor 12 both axially secures the rotor 12 to the centrifuge drive 14 as well as facilitates the transfer of torque between the centrifuge drive 14 and the rotor 12 to cause the rotor 12 to rotate with a rotation required for centrifugation of samples contained therein. The connection also provides for self-centering of the drive head 20 within the hub 22 of the rotor 12, as will be described in further detail below.

With continued reference to FIG. 1, the exemplary centrifuge rotor 12 includes a rotor body 24 and a rotor lid 26 configured to be coupled to an open end of the rotor body 24, particularly during centrifugation of a sample, for example. In that regard, the rotor body 24 is symmetrical about the axis of rotation A1 shared with the centrifuge drive 14. The rotor 12 includes a plurality of rotor wells 28 (otherwise referred to as receiving chambers or cell hole cavities) formed in the rotor body 24 and distributed radially, in a symmetrical arrangement, about a vertical bore 30 formed through the axial center of the rotor 12. Each rotor well 28 formed in the rotor body 24 is generally cylindrical in shape and is configured to receive a sample container (not shown) therein for centrifugation of a sample held in the sample container. Each rotor well 28 may be formed in the rotor body 24 so as to have a fixed angular relationship relative to the rotational axis A1 of the rotor 12. To this end, the rotor 12 may be considered a high-speed fixed-angle rotor 12, for example, which is designed to rotate at rotational speeds in the range of about 8,000 rpm to about 30,000 rpm.

While the rotor 12 is shown and described in the context of a fixed-angle rotor having certain characteristics, it will be understood that the same inventive concepts related to embodiments of the present invention may be implemented with different types of centrifuge rotors such as swinging-bucket rotors and vertical rotors, for example, without departing from the scope of the invention. For example, the inventive concepts related to embodiments of the present invention may be implemented with the following rotors (listed by model number) commercially available from the Assignee of the present disclosure: Fiberlite™ F10-6x250 LEX, Fiberlite™ F10-6x100 LEX, Fiberlite™ F15-6x100y, Fiberlite™ F15-8x50cy, Fiberlite™ F15-48x1.5/2.0, Fiberlite™ F10-14x50cy, H3-LV, Fiberlite™ F15-24x1.5/2.0, BIOShield™-720, TX-100, TX-150, TX-200, TX-400, TX-750, HIGHPlate™-6000. To this end, the drawings are not intended to be limiting. To this end, the drawings are not intended to be limiting.

With continued reference to FIG. 1, the rotor 12 includes a rotor insert 32 provided within a central interior region of the rotor body 24 that is configured to threadably engage the rotor hub 22. As shown, the rotor insert 32 is located about the rotational axis A1 and is configured to receive and threadedly engage the rotor hub 22 to hold the rotor hub 22 in place within the vertical bore 30 of the rotor 12. The engagement between the rotor insert 32 and the rotor hub 22 results in an externally threaded top portion 34 of the hub 22 being exposed from the vertical bore 30 to which a hub retainer 36 is threadably fastened to hold the hub 22 in place relative to the rotor body 24.

The rotor 12 further includes a lid screw 38 for securing the rotor lid 26 to the rotor body 24. The lid screw 38 is configured to thread into an internally threaded top portion 40 of the rotor hub 22 such that turning of the lid screw 38 to engage the hub 22 causes the lid screw 38 to press down on the lid 26, securing the lid 26 to the rotor 12. As shown, the lid screw 38, hub 22, and rotor insert 32 are coaxially arranged with the vertical bore 30 formed in the rotor body 24. The lid 26 seals closed the open end of the rotor body 24 to block access to one or more sample containers held in the rotor wells 28 during high speed rotation of the rotor 12.

Referring now to FIGS. 1-3, the hub 22 of the rotor 12 includes an internal cavity 46 configured to receive the drive head 20 of the centrifuge drive 14 therein for coupling the rotor 12 to the centrifuge drive 14. In that regard, a shape of the cavity 46 generally corresponds to a profile of the drive head 20. More particularly, the internal cavity 46 extends from an open end 48 of the hub 22 to a radially extending base surface 50 of the hub 22 to define a crown receiving portion 52 and a drive head hub receiving portion 54 of the cavity 46. The crown receiving portion 52 is defined by a beveled sidewall 56 and a first tubular sidewall 58 that extends in an axial direction between the base surface 50 and the beveled sidewall 56. The drive head hub receiving portion 54 is defined by a second tubular sidewall 60 that extends in an axial direction from the open end 48 of the hub 22 to the beveled sidewall 56. The second tubular sidewall 60 further includes an annular lip 62 configured to engage with the drive head 20 during mounting and dismounting of the rotor 12 to the drive head 20, as described in further detail below.

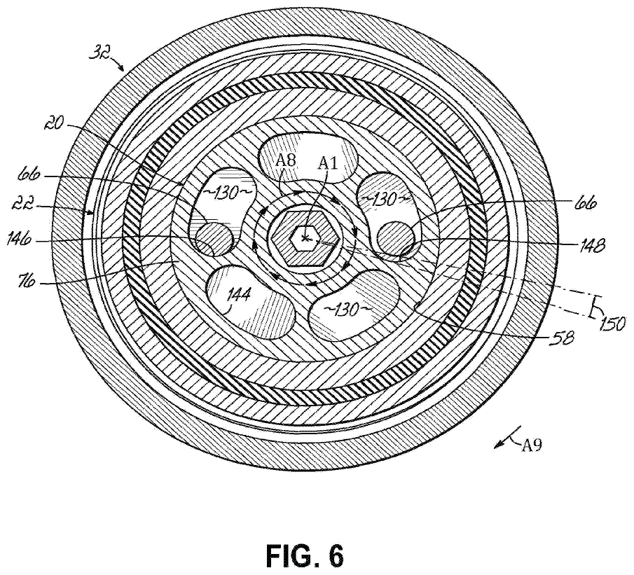

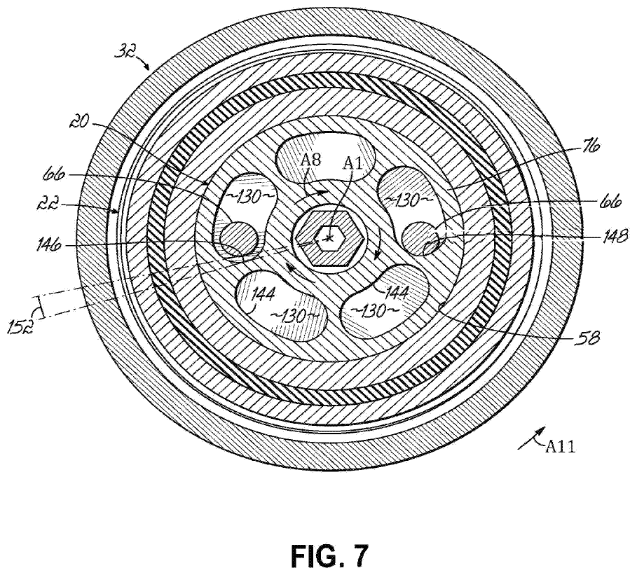

The base surface 50 of the hub 22 includes a plurality of blind bores 64 each being configured to receive a respective drive pin 66 therein. The drive pins 66 are configured to engage the drive head 20 to transfer rotational movement of the centrifuge drive 14 to the rotor 12, as described in further detail below. As shown in FIGS. 1-3, each blind bore 64 is configured to receive a corresponding drive pin 66 therein and, in the embodiment shown, the hub 22 includes two blind bore 64 and drive pin 66 combinations. The blind bore 64 and drive pin 66 combinations are spaced 180° apart from each other about the axial center of the hub 22 which is coaxial with the rotational axis A1 (e.g., FIGS. 6 and 7). However, the hub 22 may include fewer or more blind bore 64 and drive pin 66 combinations spaced apart in different configurations about the axial center of the hub 22. For example, the hub 22 may include three blind bore 64 and drive pin 66 combinations spaced 120° apart from each other about the axial center of the hub 22. In any event, the engagement between each drive pin 66 and blind bore 64 is an interference fit, otherwise referred to as a press-fit. As a result, there may be a void between a base of each blind bore 64 and the drive pin 66. However, it is understood that the drive pins 66 may be attached to the hub 22 in other ways, such as by welding or by threaded engagement, for example. In one embodiment, the hub 22 and drive pins 66 may be integrally formed as a unitary piece.

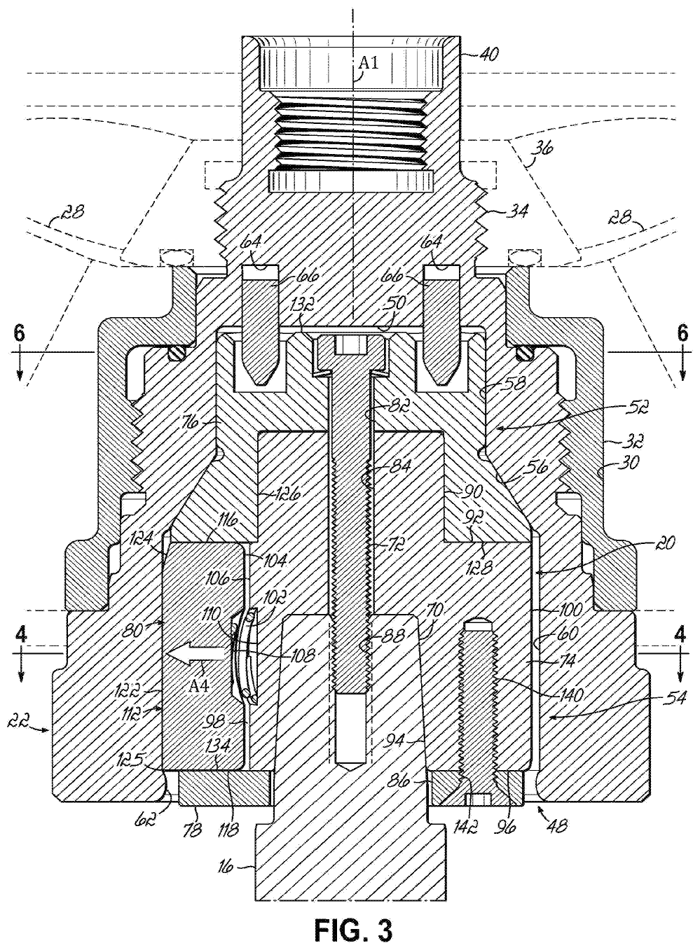

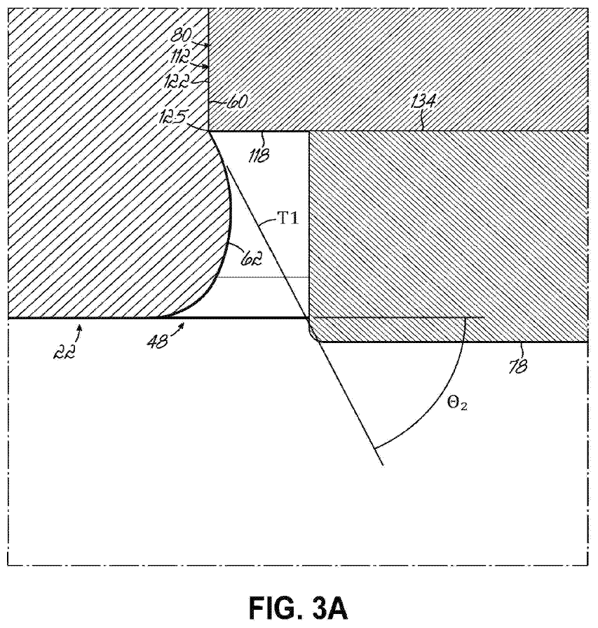

With continued reference to FIGS. 1-3, details of the drive head 20 will now be described. As shown, the drive head 20 is permanently mounted to a distal end 70 of the spindle 16 with a fastener 72 and includes a drive head hub 74, a crown 76, and a retaining plate 78 coupled together in a coaxial arrangement. The drive head hub 74 includes a plurality of radially movable locking shoes 80 that are configured to exert a radially outwardly directed force on the hub 22 of the rotor 12 that increases with a rising rotational speed of the drive head 20. In that regard, the locking shoes 80 serve to prevent axial movement of the centrifuge rotor 12 along the rotational axis A1 of the centrifuge drive 14 as well as rotational movement of the centrifuge rotor 12 relative to the drive head 20, and further provide for self-centering of the drive head 20 within the hub 22 of the rotor 12, as described in further detail below. As best shown in FIG. 3, the crown 76 and the drive head hub 74 each include a central bore 82, 84, respectively, configured to receive the fastener 72 therethrough for attaching the drive head 20 to the distal end 70 of the spindle 16. The retaining plate 78 includes a central bore 86 configured to receive the distal end 70 of the spindle 16 therethrough. To this end, the fastener 72, which may be a bolt or screw, for example, is received through aligned bores 82, 84 and threaded into a threaded bore 88 in the distal end 70 of the spindle 16.

With reference to FIGS. 1-3 and 8, the drive head hub 74 includes a generally cylindrical boss 90 that projects upwardly from a top surface 92 of the drive head hub 74 and a pocket 94 formed in a base 96 of the drive head hub 74. The pocket 94 extends a distance into the drive head hub 74 in an axial direction from the base 96 and is configured to receive a portion of the distal end 70 of the spindle 16 therein, as shown. The structure of the pocket 94 achieves the same effect as a locking cone or morse taper, resulting in a self-holding frictional engagement between surfaces of the pocket 94 and surfaces of the spindle 16. The central bore 84 formed in the drive head hub 74 extends in an axial direction between the boss 90 and the pocket 94 and is configured to receive the fastener 72 therethrough. The drive head hub 74 further includes a plurality of recesses 98 formed in an outer sidewall 100 of the drive head hub 74 with each recess 98 being configured to movably retain a respective locking shoe 80 therein.

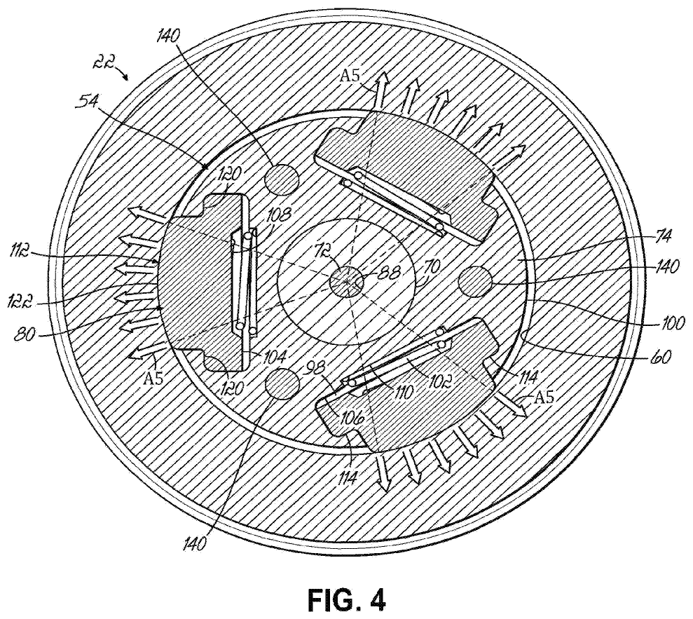

As shown in FIG. 4, for example, the plurality of recesses 98 are spaced equidistantly apart and circumferentially about the drive head hub 74 so as to be in a symmetrical arrangement. In that regard, the three locking shoes 80 are spaced 120° apart from each other about the axial center of the drive head hub 74 so as to be positioned at 0°, 120°, and 240° thereabout. The symmetrical arrangement of the plurality of recesses 98 about the drive head hub 74, and thus the locking shoes 80, provides for self-centering of the drive head 20 within the hub 22 of the rotor 12, as will be described in further detail below. While the drive head hub 74 includes three locking shoes 80, it is possible to provide fewer or more locking shoes 80. For example, the drive head hub 74 may include four locking shoes 80 spaced 90° apart from each other about the axial center of the drive head hub 74 so as to be positioned at 0°, 90°, 180°, and 270° thereabout.

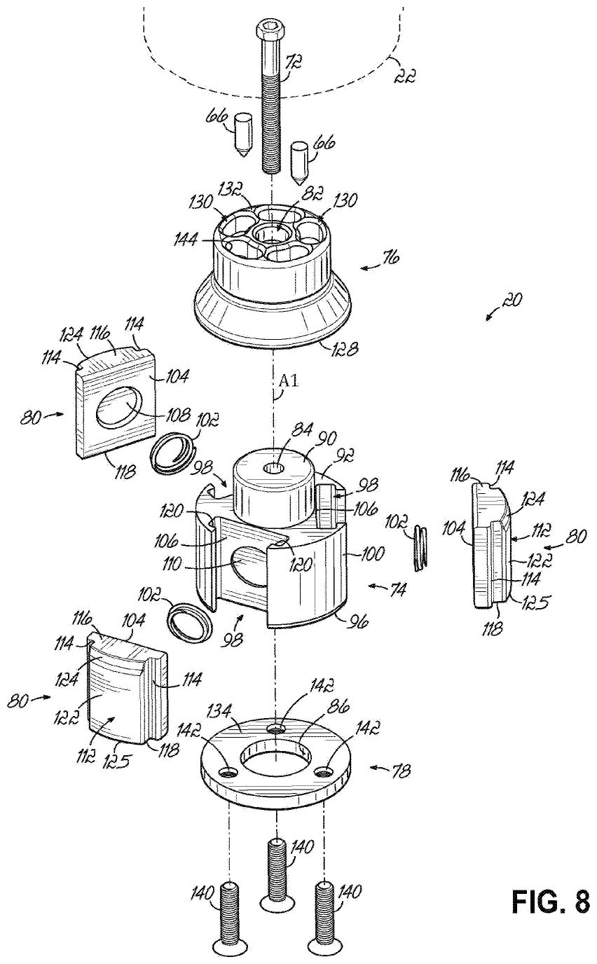

As briefly described above, each locking shoe 80 is movable within a corresponding recess 98 in a radially inward direction and a radially outward direction relative to the rotational axis A1 of the centrifuge drive 14. In particular, a resilient element 102 is located between each locking shoe 80 and the drive head hub 74 for biasing each locking shoe 80 in a radially outward direction relative to the rotational axis A1 of the centrifuge drive 14. As shown in FIG. 3, for example, the resilient element 102 may be a compression spring sandwiched between a generally flat base surface 104 of each locking shoe 80 and a generally flat base surface 106 of each recess 98. To this end, the base surface 104 of the locking shoe 80 may include a blind bore 108 formed therein and the base surface 106 of the recess 98 may include a blind bore 110 formed therein, each being configured to receive a respective end of the compression spring, as shown in FIG. 8, for example.

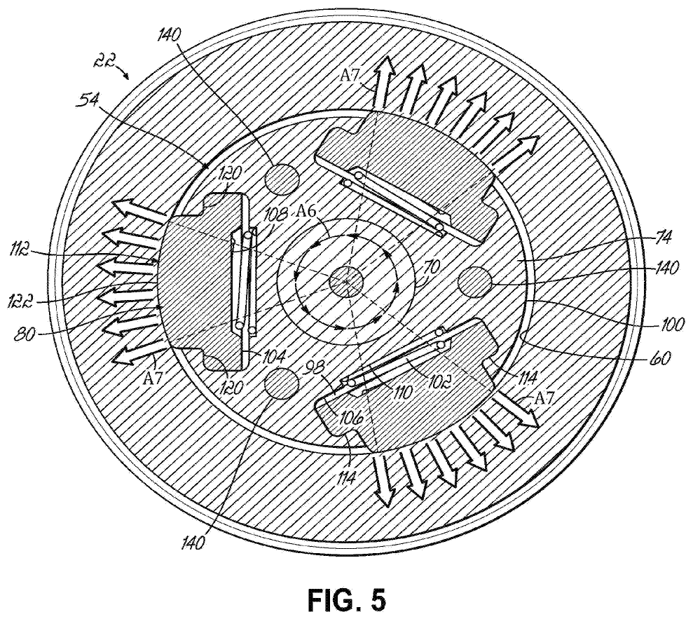

With reference to FIG. 8, each locking shoe 80 is generally “T” shaped in transverse cross-section and includes a centrally located embossment 112 that defines a pair of shoulders 114. The embossment 112 and the pair of shoulders 114 extend between a generally flat top surface 116 and a generally flat base surface 118 of each locking shoe 80. The pair of shoulders 114 are configured to engage corresponding abutment surfaces 120 defined by the recess 98 to provide a stop to prevent over-extension of the locking shoe 80 from each recess 98. As best shown in FIGS. 4 and 5, each locking shoe 80 has a material thickness at each shoulder 114 (i.e., a material thickness measured between the base surface 104 of the locking shoe 80 and the shoulder surface 114) that is less than a depth of each recess 98 (i.e., a distance between the base surface 106 and the abutment surfaces 120 of each recess 98) to provide a range of radial movement of the locking shoe 80 within the recess 98.

The embossment 112 of each locking shoe 80 defines a curved outer surface 122 that generally matches a curvature of the second tubular sidewall 60 of the hub 22, as shown in FIGS. 4 and 5, for example. To this end, each locking shoe 80 is movable between at least a first, compressed position where each locking shoe 80 is received within a corresponding one of the plurality of recesses 98 in a radially inward direction relative to the rotational axis A1 of the centrifuge drive 14 to define a first outer diameter of the drive head hub 74, and a second, extended position where each locking shoe 80, and in particular each embossment 112, extends a distance from the corresponding one of the plurality of recesses 98 in a radially outward direction relative to the rotational axis A1 of the centrifuge drive 14 such that the locking shoes 80 define a second outer diameter of the drive head hub 74 that is greater than the first outer diameter (e.g., FIGS. 4 and 5).

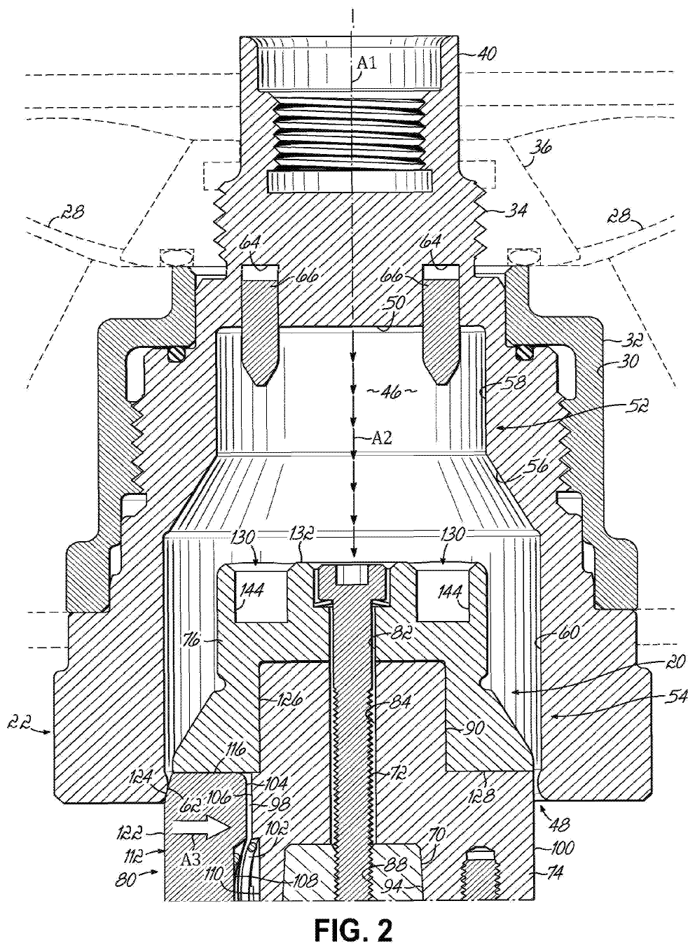

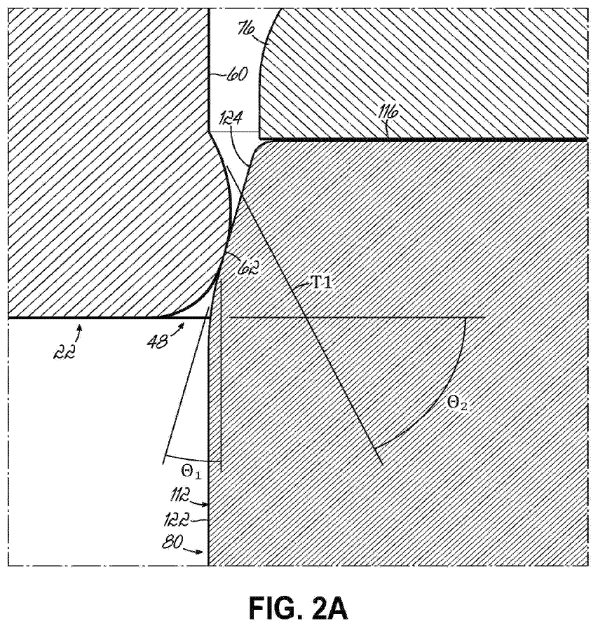

As shown in FIGS. 2 and 2A, each locking shoe 80 also includes a chamfered surface 124 that extends between the curved outer surface 122 and the top surface 116 to facilitate insertion of the drive head 20 into the hub 22 of the centrifuge rotor 12, as described in further detail below. To this end, the curved outer surface 122 extends from the base surface 118 of the locking shoe 80 to the chamfered surface 124, and the chamfered surface 124 extends from the top surface 116 to the curved outer surface 122 of the locking shoe 80. The transition between the base surface 118 and the curved outer surface 122 may be rounded to form a radiused edge 125. As shown in FIG. 2A, the chamfered surface 124 extends from the top surface 116 to the curved outer surface 122 at an angle Θ₁ of between 5° to 30° relative to vertical (e.g., the rotational axis A1). In the embodiment shown, the angle Θ₁ is between 5° to 30°.

With reference to FIGS. 1-3A and 8, the crown 76 is configured to be attached to the drive head hub 74 and includes a pocket 126 formed in a base 128 of the crown 76 that is configured to receive the boss 90 of the drive head hub 74 therein for coupling the crown 76 to the drive head hub 74. When the crown 76 is coupled to the drive head hub 74 (e.g., FIG. 3), the boss 90 of the drive head hub 74 is fully received within the pocket 126 of the crown 76 to thereby place the base 128 of the crown 76 in engagement with the top surface 92 of the drive head hub 74. To this end, the fit between the pocket 126 of the crown 76 and the boss 90 of the drive head hub 74 may be an interference fit, for example. The crown 76 further includes a plurality of torque slots 130 formed in a top surface 132 of the crown 76 with each torque slot 130 being configured to receive a corresponding drive pin 66 therein to transfer rotational movement of the centrifuge drive 14 to the centrifuge rotor 12, as described in further detail below. The central bore 82 formed in the crown 76 extends in an axial direction between the top surface 132 and the pocket 126 of the crown 76 and may include a countersink formed in the top surface 132 that is configured to receive a head of the fastener 72 therein, as shown.

With continued reference to FIGS. 1-3A and 8, the retaining plate 78 is generally shaped as an annular disc and is configured to be attached to the base 96 of the drive head hub 74 to limit axial movement of each of the plurality of locking shoes 80 within each respective recess 98 formed in the drive head hub 74. In that regard, each locking shoe 80 is movable in a radial direction within each recess 98 such that the top surface 116 of each locking shoe 80 slideably engages the base surface 128 of the crown 76 and the bottom surface 118 of each locking shoe 80 slideably engages a top surface 134 of the retaining plate 78. In one embodiment, a first friction reducing insert may be positioned between each locking shoe 80 and the base surface 128 of the crown 76 and a second friction reducing insert may be positioned between each locking shoe 80 and the top surface 134 of the retaining plate 78. The friction reducing inserts may be formed from an engineered plastic such as Delrin®, for example, or any other suitable low friction material. The retaining plate 78 is attached to the drive head hub 74 with fasteners 140 received through respective mounting bores 142 formed in the retaining plate 78. The fasteners 140 may be screws or bolts, for example, and each mounting bore 142 may include a countersink configured to receive a head of the fastener 140 therein, as shown in FIG. 3, for example.

Having now described certain details of the rotor 12 and the drive head 20 of the centrifuge 10, the tool-less engagement between the drive head 20 and the hub 22 of the rotor 12 will now be described in connection with FIGS. 1-3A. In that regard, when the rotor 12 is to be connected with the drive head 20, the rotor 12 is positioned over the drive head 20 to align the drive head 20, and specifically the crown 76, within the hub 22 of the rotor 12, as shown in FIG. 2. The rotor 12 is then moved downwardly, as indicated by directional arrow A2, until the annular lip 62 engages with each locking shoe 80. In particular, the annular lip 62 first engages with the chamfered surface 124 of each locking shoe 80. Lowering of the rotor 12 and the continued engagement between the annular lip 62 and the chamfered surface 124 of each locking shoe 80 moves the locking shoes 80 in a radially inward direction into each respective recess 98, as indicated by directional arrow A3.

The open end 48 of the rotor hub 22 is able to slide past the locking shoes 80 during further lowering of the rotor 12 in the axial direction A2 until the crown 76 is received within the crown receiving portion 52 of the rotor hub 22 and the drive head hub 20 is received within the drive head hub receiving portion 54 of the rotor hub 22, as shown in FIG. 3. In that regard, the matching profiles of the crown receiving portion 52 and the crown 76 serve to align the drive head 20 within the rotor hub 22 as the rotor 12 is being lowered over the drive head 20. That way, as the rotor 12 is lowered in the axial direction A2, the drive pins 66 are correctly positioned within respective torque slots 130 in the crown 76 for transferring rotational movement of the centrifuge drive 14 to the centrifuge rotor 12, as described in further detail below.

Once the annular lip 62 passes by the base surface 118 of each locking shoe 80, as shown in FIG. 3, each locking shoe 80 is moved in a radially outward direction as a result of the spring force exerted on each locking shoe 80 by the resilient element 102, as indicated by directional arrow A4, to place the curved outer surface 122 of each locking shoe 80 in engagement with the second sidewall 60 of the rotor hub 22. In that regard, the spring force acting on each locking shoe 80 is generally perpendicular to the rotational axis A1, as shown. The symmetrical arrangement of the locking shoes 80 in combination with the spring force acting on each locking shoe 80 results in a self-centering effect of the drive head 20 within the rotor hub 22. To this end, the drive head 20 may be received within the rotor hub 22 for coupling the rotor 12 to the centrifuge drive 14 in a tool-less manner and without the need for extra assembly features or actuators to depress the locking shoes 80, for example.

As shown in FIGS. 3 and 3A, when the drive head 20 is fully seated within the rotor hub 22, the radiused edge 125 of each locking shoe 80 is engaged with an upper radiused portion of the annular lip 62 of the rotor hub 22. Tangent plane T1 is representative of a plane defined by the surfaces of the curved edge 125 of each locking shoe 80 and an upper radiused portion of the annular lip 62 that are in contact. As shown, the tangent plane T1 is angled relative to horizontal to define a pressure angle Θ₂ which is less than 45°. In the embodiment shown, the pressure angle Θ₂ is 38°, however, other preferred angles for Θ₂ are 25° and 42°, for example. During removal of the rotor 12 from the drive head 20, a lifting force F_{L} is generated between the hub 22 of the rotor 12 and each locking shoe 80 along the contact line therebetween. As a result of the engagement between the hub 22 of the rotor 12 and each locking shoe 80, the lifting force F_{L} breaks down into the following components: F_{L1}=1/3*F_{L}*cos Θ₂ and F_{L2}=1/3*F_{L}*sin Θ₂. To this end, the pressure angle Θ₂ must be less than 45° because the vertical component F_{L2} should be less than the horizontal component F_{L1} so that the rotor 12 may be removed from the locking head 20 by hand with minimal effort. During rotation of the rotor 12 by the drive head 20, the force totals between each locking shoe 80 and the rotor hub 22 are balanced to generate a balanced force vector sum.

Referring now to FIGS. 4 and 5, and as briefly described above, each locking shoe 80 is configured to exert a radially outwardly directed force on the hub 22 of the rotor 12 that increases with a rising rotational speed of the drive head 20. The radially outwardly directed force exerted by each locking shoe 80 on the hub 22 of the rotor 12 serves to prevent axial movement of the centrifuge rotor 12 along the rotational axis A1 of the centrifuge drive 14 as well as rotational movement of the centrifuge rotor 12 relative to the drive head 20. In that regard, FIG. 4 illustrates the contact force between each locking shoe 80 and the hub 22 when the rotor 12 is stationary. As the curvature of the curved outer surface 122 of each locking shoe 80 matches, or coincides with the curvature of the second sidewall 60 of the rotor hub 22, the entirety of the curved outer surface 122 of each locking shoe 80 engages the second sidewall 60. As a result, the spring force from the resilient element 102 acting on each locking shoe 80 is distributed across the curved outer surface 122 of each locking shoe 80 to generate a first radial contact force between the curved outer surface 122 of each locking shoe 80 and the second sidewall 60, as indicated by directional arrows A5. To this end, the contact forces A5 are perpendicular to the rotational axis A1.

FIG. 5 illustrates the contact force between each locking shoe 80 and the hub 22 when the rotor 12 is rotating at a particular speed, as indicated by directional arrows A6. During rotation of the rotor 12 by the drive head 20, a second contact force between each locking shoe 80 and the hub 22 is generated, as indicated by directional arrows A7, that is greater than the first contact force A5 described above with respect to FIG. 4. More particularly, the second contact force A7 is a combination of the spring force from the resilient element 102, as described above, and a centrifugal force component F_{c} based on a rotational speed of the drive head 20. As shown, the second contact force A7 is also distributed between the curved outer surface 122 of each locking shoe 80 and the second sidewall 60. The centrifugal force component F_{c} of each shoe can be determined using the following formula: F_{c}=m*r*Ω², where “m” is the weight of the locking shoe 80, “r” is the distance between the rotational axis A1 of the rotor 12 and a center of mass of the locking shoe 80, and “Q” is a rotational velocity of the rotor 12. As the rotational speed of the drive head 20 increases, and thus a rotational speed of the rotor 12, the centrifugal force component F_{c} acting on each locking shoe 80 also increases, thereby increasing the second contact force A7 between each locking shoe 80 and the hub 22. Testing was run on a prototype of the centrifuge 10 assembly described above to determine the combined centrifuge forces (F_{c}*3) imparted by the locking shoes 80 to the rotor hub 22. Table 1 below illustrates those testing results.

TABLE 1

| | Rotor rotational speed in revolutions-per-minute (rpm) | | | | | | | | |
|---|---|---|---|---|---|---|---|---|---|
| | 3000 | 5000 | 10000 | 12000 | 14000 | 16500 | 21000 | 30000 | 40000 |
| Combined centrifugal | 142 | 395 | 1,579 | 2,274 | 3,095 | 4,299 | 6,964 | 14,211 | 25,266 |
| force component of | | | | | | | | | |
| locking shoes in | | | | | | | | | |
| Newtons (F_{c}*3) | | | | | | | | | |

To this end, deceleration of the rotor 12 decreases the second contact force A7 between each locking shoe 80 and the hub 22.

The contact forces A5, A7 between each locking shoe 80 and the hub 22 cause a static friction coefficient F_{sf} (e.g., a radial and an axial holding force, otherwise referred to as a friction force) between each locking shoe 80 and the sidewall 60 of the rotor hub 22. In that regard, the static friction coefficient F_{sc} is a function of the coefficient of friction “μ” between the contacting surfaces 122, 60 and the contact forces A5, A7. That is, F_{sf}=μ*F_{c}. Generally, as the contact forces A5, A7 increase with the increase of rotor 12 speed, so does the static friction coefficient F_{sf} (e.g., the radial and axial holding forces). As each locking shoe 80 and the hub 22 of the rotor 12 may be formed from steel, such as 316L stainless steel, for example, the coefficient of friction u between the curved outer surface 122 of each locking shoe 80 and the sidewall 60 of the rotor hub 22 may be between 0.3 to 0.5, for example. However, the surface roughness of the curved outer surface 122 of each locking shoe 80 and the sidewall 60 of the rotor hub 22 may be changed to improve the coefficient of friction u therebetween. For example, the surfaces 122, 60 may be machined and processed with different Ra (roughness average), such as 15 Ra, for example, resulting in a coefficient of friction μ therebetween that is within a range of between 0.3 to 0.8, for example.

In view of the above, the weight of each locking shoe 80 is an important design requirement for the operation of the drive head 20. In that regard, the weight of each locking shoe 80 should be as heavy as possible to increase the value of F_{sf}, particularly at lower rotational speeds of the rotor 12. To this end, the three locking shoe 80 design provides for both the self-centering effect of the drive head hub 20 as well as a large size and mass of each locking shoe 80. Thus, while it is possible to have fewer or more locking shoes 80, such as two or four, for example, each design sacrifices either the self-centering effect (e.g., two locking shoes 80) or requires a smaller size and thus smaller mass of each locking shoe 80 (e.g., four locking shoes 80).

During the above-mentioned testing, another advantage of the connection between the drive head 20 and the rotor 12 during operation of the centrifuge 10 was observed. In that regard, the centrifuge 10 was observed to be exceptionally quiet during operation, and the decibel (dB) output was measured to be 57.6 dB at a rotational speed of 10,000 rpm.

Referring now to FIGS. 3 and 6-8, when the drive head 20 is fully seated within the rotor hub 22, as shown in FIG. 3, the rotor 12 is considered mounted to the centrifuge drive 14. When so positioned, the drive pins 66 are received within respective torque slots 130 and configured to engage a sidewall 144 of each respective torque slot 130 to minimize movement of the drive head 20 relative to the rotor 12 during initial acceleration or deceleration of the rotor 12 by the drive 14. The engagement between the drive pins 66 and the torque slots 130 may also transfer rotational movement of the centrifuge drive 14 to the centrifuge rotor 12 during initial acceleration or deceleration of the rotor 12 by the drive 14. As shown in FIGS. 6-8, the torque slots 130 are formed as oblong arc-shaped blind bores having a slightly curved profile that generally conforms to a circumference of the top surface 132 of the crown 76. In that regard, the torque slots 130 are formed in the top surface 132 of the crown 76 and are spaced apart circumferentially, in an end-to-end symmetrical arrangement, about the bore 82 formed through the axial center of the crown 76. To this end, while the crown 76 includes five torque slots 130, it is possible to provide fewer or more torque slots 130.

As shown in FIGS. 6 and 7, the drive head 20 is fully seated within the rotor hub 22 resulting in a first drive pin 66 being positioned in an abutting or near-abutting relationship with a leftmost arcuate portion 146 of the sidewall 144 of a first torque slot 130 (i.e., a leftmost portion of the torque slot sidewall 144 measured in a radial direction about the axial center of the crown 76) and a second drive pin 66 is positioned in an abutting or near-abutting relationship with a rightmost arcuate portion 148 of the sidewall 144 of a second torque slot 130 (i.e., a rightmost portion of the torque slot sidewall 144 measured in a radial direction about the axial center of the crown 74). As shown, the first drive pin 66 and the second drive pin 66 do not both abut the arcuate portions 146, 148 of the sidewalls 144 of the first and second torque slots 130 at the same time. Rather, only one of the drive pins 60 is in an abutting relationship with the respective arcuate portion 146, 148 of the torque slot sidewall 144, depending on whether the rotor 12 is being accelerated or decelerated. This configuration results in a small gap being formed between the drive pin 60 and the corresponding sidewall 144 that are not engaged, as described in further detail below.

FIG. 6 illustrates the rotor 12 being accelerated to a particular rotational speed by the drive head 20, as indicated by directional arrows A8. As shown, during acceleration, the first drive pin 66 is in an abutting relationship with the leftmost arcuate portion 146 of the sidewall 144 of the first torque slot 130 to transfer torque from the drive head 20 to the rotor 12, as indicated by directional arrow A9. To this end, the engagement between the first drive pin 66 and the first torque slot 130 prevents rotation of the drive head 20 relative to the rotor 12 during acceleration of the rotor 12 by the centrifuge drive 14. Also during acceleration of the rotor 12, the second drive pin 66 is spaced away from the rightmost arcuate portion 148 of the sidewall 144 of the second torque slot 130 such that a gap 150 is formed therebetween. The size of the gap 150 determines the range of movement that the rotor 12 may rotate independently of the drive head 20, otherwise referred to as rotational slippage or play.

FIG. 7 illustrates the rotor 12 during deceleration or braking of the rotor 12 by the drive 14. As indicated by directional arrows A10, the rotor 12 is rotating at a particular rotational speed that is less than the speed of the rotor 12 illustrated in FIG. 6. In that regard, during deceleration of the rotor 12 by the drive 14, the second drive pin 66 is in an abutting relationship with the rightmost arcuate portion 148 of the sidewall 144 of the second torque slot 130 to transfer torque from the drive head 20 to the rotor 12, as indicated by directional arrow A11. To this end, the engagement between the second drive pin 66 and the second torque slot 130 prevents rotation of the drive head 20 relative to the rotor 12 during deceleration of the rotor 12 by the centrifuge drive 14. Also during deceleration of the rotor 12, the first drive pin 66 is spaced away from the leftmost arcuate portion 146 of the sidewall 144 of the first torque slot 130 such that a gap 152 is formed therebetween. The size of the gap 152 may the similar to the gap 150 described above with respect to FIG. 6.

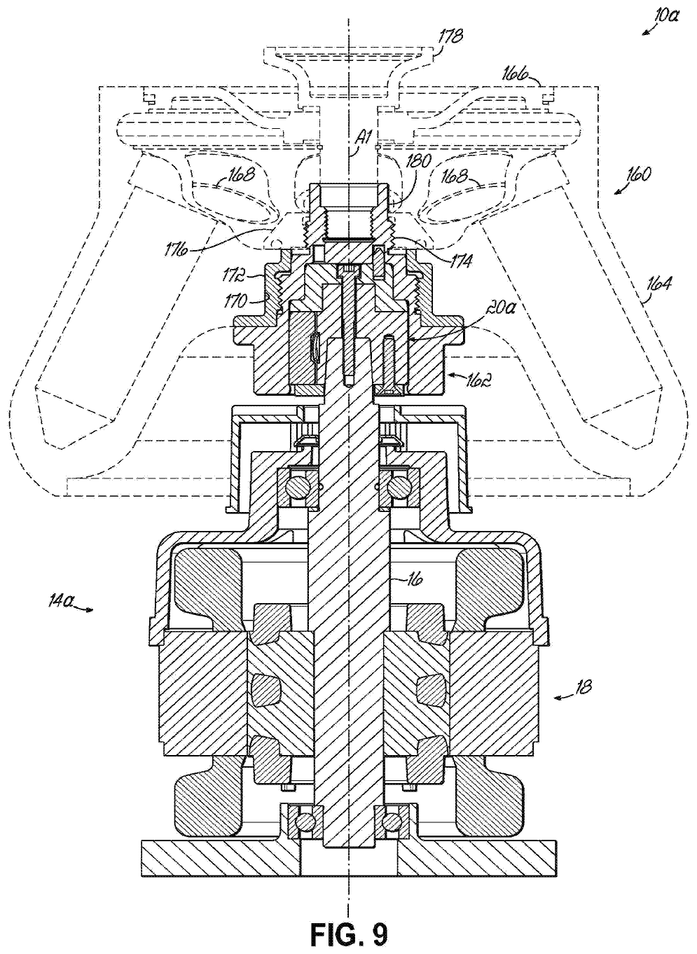

Referring now to FIGS. 9-12, wherein like numerals represent like features, another exemplary centrifuge 10a in accordance with a second embodiment of the present invention is shown without any substructure. The centrifuge 10a includes a centrifuge rotor 160 operatively coupled to the centrifuge drive 14a having the drive shaft, or spindle 16, driven by the motor 18 for rotating the rotor 160 about the rotational axis A1 to achieve high-speed, centrifugal rotation of the rotor 160. As shown, the centrifuge drive 14a includes a drive head 20a positioned at one end of the spindle 16 that is configured to be received within a hub 162 of the rotor 160 for detachably connecting the rotor 160 to the centrifuge drive 14a in a tool-less manner. The primary differences between the centrifuge 10a of this embodiment and the centrifuge 10 of the previously described embodiment is the configuration of the drive head 20a. To accommodate the different configuration of the drive head 20a, the configuration hub 162 of the rotor 160 is also different compared to the previously described embodiment.

With reference to FIG. 9, the exemplary centrifuge rotor 160 includes a rotor body 164 and a rotor lid 166 configured to be coupled to an open end of the rotor body 164, and the rotor body 164 is symmetrical about the axis of rotation A1 shared with the centrifuge drive 14a. The rotor 160 includes a plurality of rotor wells 168 (otherwise referred to as receiving chambers or cell hole cavities) formed in the rotor body 164 and distributed radially, in a symmetrical arrangement, about a vertical bore 170 formed through the axial center of the rotor 160. Each rotor well 168 formed in the rotor body 164 is generally cylindrical in shape and is configured to receive a sample container (not shown) therein for centrifugation of a sample held in the sample container. Each rotor well 168 may be formed in the rotor body 164 so as to have a fixed angular relationship relative to the rotational axis A1 of the rotor 160, and the rotor 160 may be considered a high-speed fixed-angle rotor, for example.

With continued reference to FIG. 9, the rotor 160 includes a rotor insert 172 provided within a central interior region of the rotor body 164 that is configured to threadably engage the rotor hub 162. In this regard, the rotor insert 172 is located about the rotational axis A1 and is configured to receive and threadedly engage the rotor hub 162 to hold the rotor hub 162 in place within the vertical bore 170 of the rotor 160. The engagement between the rotor insert 172 and the rotor hub 162 results in an externally threaded top portion 174 of the hub 162 being exposed from the vertical bore 170 to which a hub retainer 176 is threadably fastened to hold the hub 162 in place relative to the rotor body 164.

The rotor 160 further includes a lid screw 178 for securing the rotor lid 166 to the rotor body 164. The lid screw 178 is configured to thread into an internally threaded top portion 180 of the rotor hub 162 such that turning of the lid screw 178 to engage the hub 162 causes the lid screw 178 to press down on the lid 166, securing the lid 166 to the rotor 160. As shown, the lid screw 178, hub 162, and rotor insert 172 are coaxially arranged with the vertical bore 170 formed in the rotor body 164. To this end, the lid 166 seals closed the open end of the rotor body 164 to block access to one or more sample containers held in the rotor wells 168 during high speed rotation of the rotor 160.

As shown, the hub 162 of the rotor 160 includes an internal cavity 182 configured to receive the drive head 20a of the centrifuge drive 14a therein for coupling the rotor 160 to the centrifuge drive 14a. In that regard, the shape of the cavity 182 generally corresponds to a profile of the drive head 20a. More particularly, the internal cavity 182 extends in a stepped manner from an open end 184 of the hub 162 to a radially extending base surface 186 of the hub 162. In that regard, the internal cavity 182 is defined by a first tubular sidewall 188 that extends from the base surface 186 of the hub 162 to a shoulder 190, and a second tubular sidewall 192 that extends from the shoulder 190 to the open end 184 of the hub 162. To this end, the stepped profile of the rotor hub 162 serves to align the drive head 20a within the rotor hub 162 during installation of the rotor 160 to the drive head 20a.

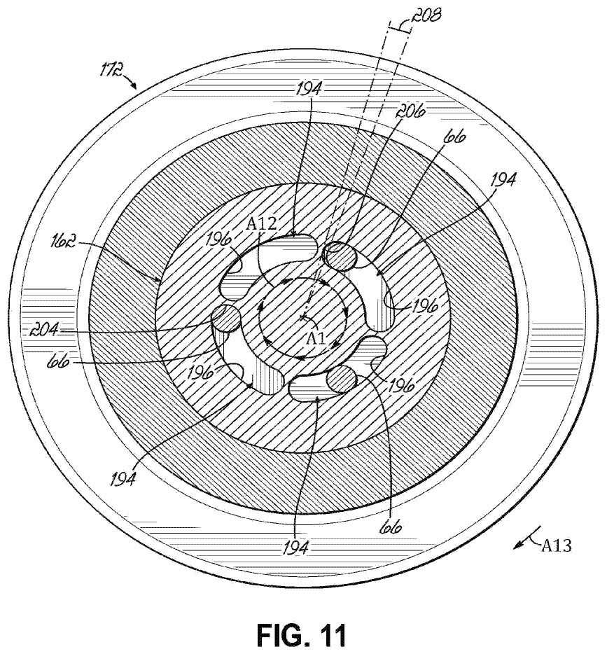

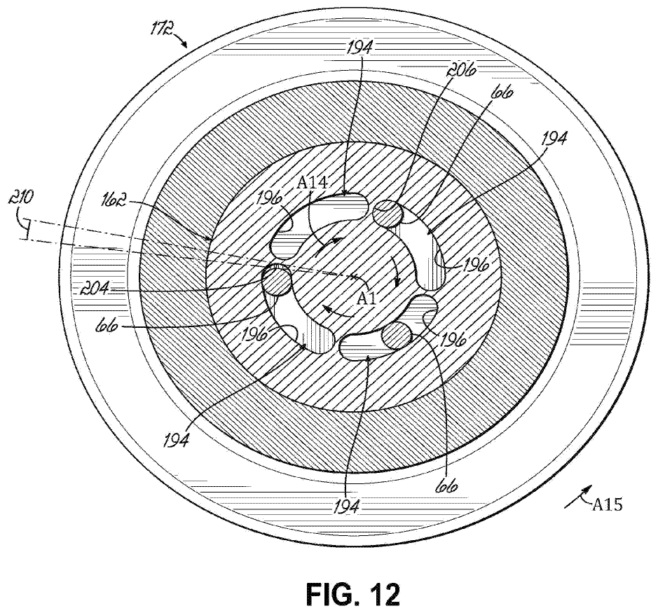

With reference to FIGS. 9-12, the base surface 186 of the rotor hub 162 includes a plurality of torque slots 194 formed therein. Each torque slot 194 defines a sidewall 196 and is configured to receive a corresponding drive pin 66 of the drive head 20a therein to transfer rotational movement of the centrifuge drive 14a to the centrifuge rotor 160, as described in further detail below. As best shown in FIGS. 11 and 12, the torque slots 194 are formed as oblong arc-shaped blind bores having a slightly curved profile that generally conforms to a circumference of the base surface 186 of the hub 162. In that regard, the torque slots 194 are formed in the base surface 186 of the rotor hub 162 and are spaced apart circumferentially, in an end-to-end symmetrical arrangement, about the axial center of the rotor hub 162. To this end, while the rotor hub 162 includes four torque slots 194, it is possible to provide fewer or more torque slots 194.

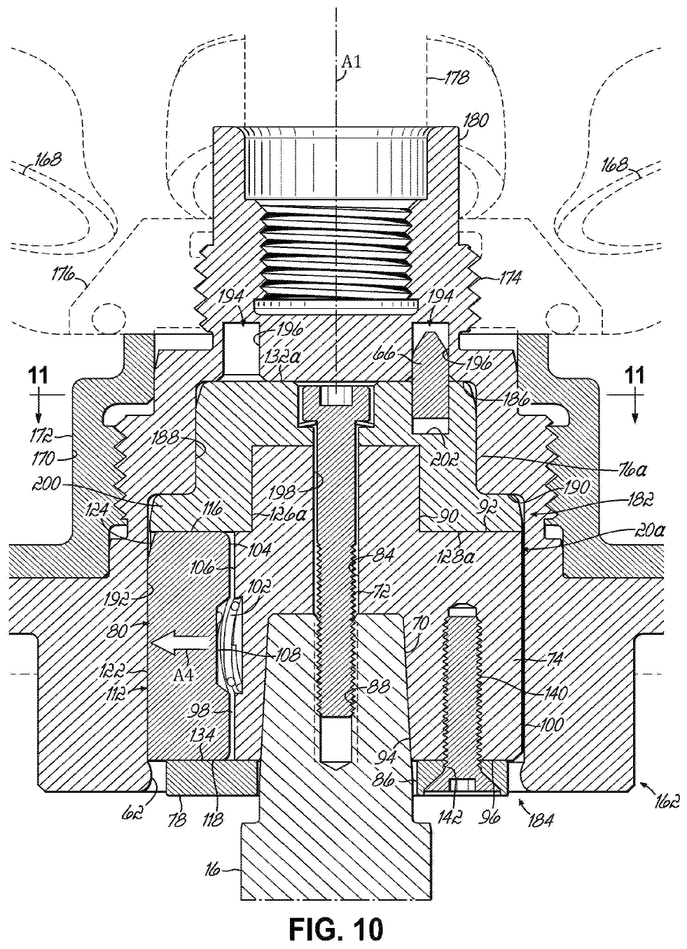

With reference to FIGS. 9 and 10, the drive head 20a is mounted to the distal end 70 of the spindle 16 with a fastener 72 and includes a drive head hub 74, a crown 76a, and a retaining plate 78 coupled together in a coaxial arrangement. The crown 76a, drive head hub 74 and the retaining plate 78 each include a central bore 198, 84, 86, respectively, configured to receive the fastener 72 therethrough for attaching the drive head 20a to the distal end 70 of the spindle 16. Like the drive head 20 described above with respect to FIGS. 1-8, the drive head hub 74 includes a plurality of radially movable locking shoes 80 that are configured to exert a radially outwardly directed force on the hub 162 of the rotor 160 that increases with a rising rotational speed of the drive head 20a. Each locking shoe 80 is movably retained within a corresponding recess 98 formed in an outer sidewall 100 of the drive head hub 74. A resilient element 102 is located between each locking shoe 80 and the drive head hub 74, and each locking shoe 80 is movable within a corresponding recess 98 in a radially inward direction and a radially outward direction relative to the rotational axis A1 of the centrifuge drive 14a. More particularly, each locking shoe 80 slideably the base surface 128a of the crown 76a and a top surface 134 of the retaining plate 78. To this end, each locking shoe 80 is configured to exert a radially outwardly directed force on the second sidewall 192 of the hub 162 of the centrifuge rotor 160, that increases with a rising rotational speed of the drive head 20a, to prevent axial movement of the centrifuge rotor 160 along the rotational axis A1 of the centrifuge drive 14a and rotational movement of the centrifuge rotor 160 relative to the drive head 20a.

The crown 76a is configured to be attached to the drive head hub 74 and includes a pocket 126a formed in the base 128a of the crown 76a that is configured to receive the boss 90 of the drive head hub 74 therein for coupling the crown 76a to the drive head hub 74. When the crown 76a is coupled to the drive head hub 74 (e.g., FIGS. 9 and 10), the boss 90 of the drive head hub 74 is fully received within the pocket 126a of the crown 76a to thereby place the base 128a of the crown 76a in engagement with the top surface 92 of the drive head hub 74. To this end, the fit between the pocket 126a of the crown 76a and the boss 90 of the drive head hub 74 may be an interference fit, for example.

The crown 76a has a generally stepped profile and includes an annular flange 200 configured to engage the top surface 92 of the drive head hub 74, as shown. Formed in the top surface 132a of the crown 76a are a plurality of blind bores 202 that are configured to receive a respective drive pin 66 therein. As shown, the drive pins 66 are configured to be received within respective torque slots 194 in the rotor hub 162 to transfer rotational movement of the centrifuge drive 14a to the rotor 160, as described in further detail below. As shown in FIGS. 11 and 12, the crown 76a includes three blind bore 202 and drive pin 66 combinations. The blind bore 202 and drive pin 66 combinations are spaced 120° apart from each other about the axial center of the crown 76a which is coaxial with the rotational axis A1 (e.g., FIG. 9). However, the crown 76a may include fewer or more blind bore 202 and drive pin 66 combinations spaced apart in different configurations about the axial center of the crown 76a. For example, the crown 76a may include two blind bore 202 and drive pin 66 combinations. In any event, the engagement between each drive pin 66 and blind bore 202 is an interference fit, otherwise referred to as a press-fit. To this end, there may be a gap between a base of each blind bore 202 and the drive pin 66 to facilitate the press-fit engagement therebetween, as shown. However, it is understood that the drive pins 66 may be attached to the crown 76a in other ways, such as by welding, for example. In one embodiment, the crown 76a and the drive pins 66 may be integrally formed as a unitary piece.

With reference to FIGS. 11 and 12, the drive head 20a is fully seated within the rotor hub 162 resulting in a first drive pin 66 being positioned within a first torque slot 194, a second drive pin 66 being positioned within a second torque slot 194, and a third drive pin 66 being positioned within a third torque slot 194. In particular, the first drive pin 66 is in an abutting or near-abutting relationship with a rightmost arcuate portion 204 of the sidewall 196 of the first torque slot 194 (i.e., a rightmost portion of the torque slot sidewall 196 measured in a radial direction about the axial center of the rotor hub 162) and the second drive pin 66 is positioned in an abutting or near-abutting relationship with a leftmost arcuate portion 206 of the sidewall 196 of the second torque slot 194 (i.e., a leftmost portion of the torque slot sidewall 196 measured in a radial direction about the axial center of the rotor hub 162). The third drive pin 66 is positioned centrally within the third torque slot 194. Like the embodiment described above with respect to FIGS. 1-8, the first drive pin 66 and the second drive pin 66 do not both abut the arcuate portions 204, 206 of the sidewalls 196 of the first and second torque slots 194 at the same time. Rather, only one of the drive pins 66 is in an abutting relationship with the respective arcuate portion 204, 206 of the torque slot sidewall 196, depending on whether the rotor 160 is being accelerated or decelerated.

FIG. 11 illustrates the rotor 160 being accelerated to a particular rotational speed by the drive head 20a, as indicated by directional arrows A12. As shown, during acceleration, the first drive pin 66 is in an abutting relationship with the rightmost arcuate portion 204 of the sidewall 196 of the first torque slot 194 to transfer torque from the drive head 20a to the rotor 160, as indicated by directional arrow A13. To this end, the engagement between the first drive pin 66 and the first torque slot 194 prevents rotation of the drive head 20a relative to the centrifuge rotor 160 during acceleration of the centrifuge rotor 160 by the centrifuge drive 14a. Also during acceleration of the rotor 160, the second drive pin 66 is spaced away from the leftmost arcuate portion 206 of the sidewall 196 of the second torque slot 194 such that a gap 208 is formed therebetween.

FIG. 12 illustrates the rotor 160 during deceleration or braking, as indicated by directional arrows A14. In that regard, the rotor 160 is rotating at a particular rotational speed that is less than the speed of the rotor 160 illustrated in FIG. 11. As shown, during deceleration, the second drive pin 66 is in an abutting relationship with the leftmost arcuate portion 206 of the sidewall 196 of the second torque slot 194 to transfer torque from the drive head 20a to the rotor 160, as indicated by directional arrow A15. To this end, the engagement between the second drive pin 66 and the second torque slot 194 prevents rotation of the drive head 20a relative to the centrifuge rotor 160 during deceleration of the centrifuge rotor 160 by the centrifuge drive 14a. Also during deceleration of the rotor 160, the first drive pin 66 is spaced away from the leftmost arcuate portion 204 of the sidewall 196 of the first torque slot 194 such that a gap 210 is formed therebetween. As a result of the three drive pin 66 and four torque slot 194 configuration, the gaps 208, 210 are smaller compared to the gaps 150, 152 of the embodiment described above with respect to FIGS. 1-8. As a result, the slippage between the rotor 160 and the drive head 20a during transient acceleration or braking of the rotor 160 is negligible.

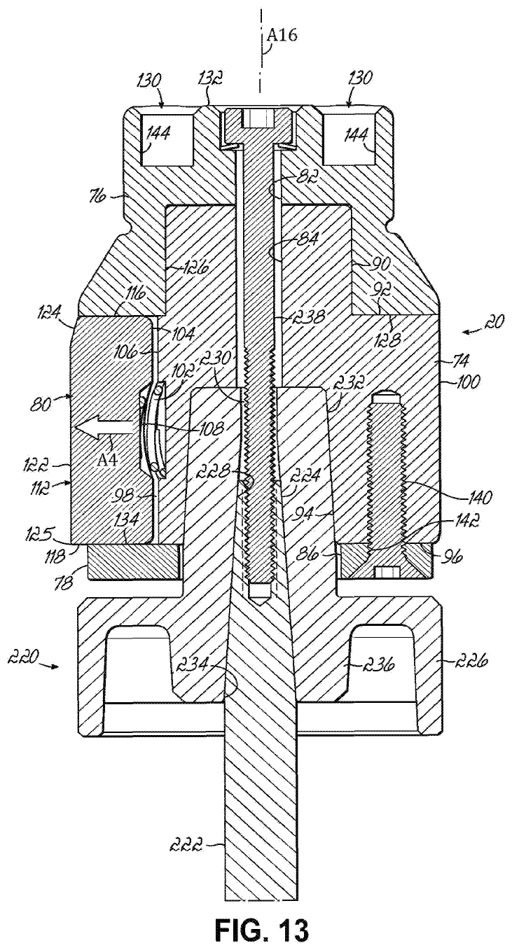

Referring now to FIG. 13, wherein like numerals represent like features, details of an adapter 220 for attaching either of the above-described drive heads 20, 20a to a spindle 222 of a centrifuge (not shown) that has different dimensions compared to the spindle 16 of the centrifuges 10, 10a described above are shown in accordance with another embodiment of the invention. In that regard, the distal end 224 of the spindle 222 is smaller in diameter compared to the distal end 70 of the spindle 16 described above, and consequently would not properly fit within the pocket 94 formed in the base 96 of the drive head hub 74. In another embodiment, an adapter may be provided to attach the drive head 20, 20a to the distal end 224 of a spindle that is larger in diameter compared to the distal end 70 of the spindle 16 described above. As described in further detail below, the adapter 220 fits to the distal end 224 of the spindle 222 and a portion of the adapter 220 is received within the pocket 94 of the drive head hub 74 so that the drive head 20 may be operably coupled to the spindle 222.

With continued reference to FIG. 13, the adapter 220 includes a cupped flange 226 and a mounting bore 228 that extends axially through the adapter 220 and between a first opening 230 to the mounting bore 228 formed in a first projection 232 of the adapter 220 and a second opening 234 to the mounting 228 formed in a second projection 236 of the adapter 220. The first and second projections 232, 236 project from the flange in axially opposite directions such that the mounting bore 228 is formed through the axial center of the adapter 220. As shown, the axial center of the adapter 220 is coaxial with an axis of rotation A16 of the spindle 222, the drive head 20, and the adapter 220. The first opening 230 formed in the first projection 232 has a diameter that is smaller in size compared to a diameter of the second opening 234 formed in the second projection 236. In that regard, a diameter of the mounting bore 228 gradually decreases in size along an axial length of the mounting bore 228 and in a direction from the second opening 234 to the first opening 230. As such, the mounting bore 228 is generally frustoconical in shape. To this end, the configuration of the mounting bore 228 may be changed depending on the type of centrifuge being used.

As shown, the second opening 234 is configured to receive the distal end 224 of the spindle 222 therethrough and the first opening 230 is configured to receive a fastener 238 therethrough for securing the adapter 220 and the drive head 220 to the spindle 222. In that regard, the distal end 224 of the spindle 222 is received into the mounting bore 228 through the second opening 234 to position the distal end 224 of the spindle 222 within the mounting bore 228, as shown. The fit between the distal end 224 of the spindle 222 and the mounting bore 228 may be a friction fit to secure the adapter 220 to the spindle 222, for example. To this end, the mounting bore 228 may have different configurations based on the configuration of the spindle 222. For example, the mounting bore 228 may have a constant diameter between the first opening 230 and the second opening 234.

The first projection 232 of the adapter 220 is generally frustoconical in shape and is sized to be received within the pocket 94 of the drive head hub 74 to couple the drive head 20 to the adapter 220, as shown. That is, an outer profile of the first projection 232 generally corresponds to a profile of the pocket 94. The fit between the first projection 232 of the adapter 220 and the pocket 94 of the drive head hub 74 may be a friction fit, for example. The adapter 220 is configured to be sandwiched between the drive head 20 and the distal end 224 of the spindle 222 in a coaxial arrangement, as shown, with the drive head 20 and the adapter 220 being mounted to the distal end 70 of the spindle 16 with the fastener 238. To this end, the fastener 238, which may be a bolt or screw, for example, is received through aligned bores 82, 84 and the mounting bore 228 of the adapter 220, and threaded into a threaded bore 240 in the distal end 224 of the spindle 222 to secure the drive head 20 and the adapter 220 to the spindle 222.

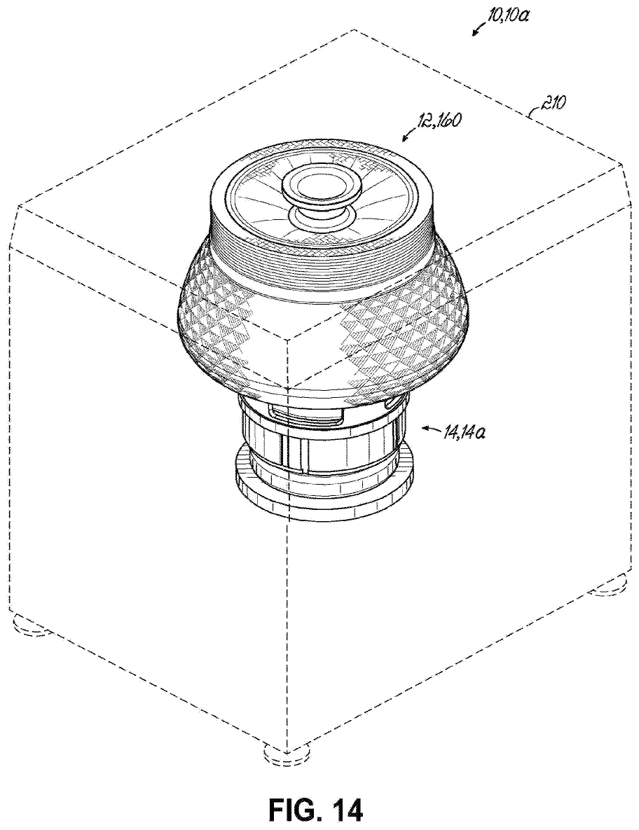

FIG. 14 depicts the exemplary centrifuge 10, 10a which includes a housing 212, the drive 14, 14a, and one of the above-described rotors 12, 160 coupled to the drive 14, 14a with one of the above-described drive heads 20, 20a. In operation, the drive 14, 14a imparts rotation to the spindle (not shown) that, in turn, provides a rotational torque to the rotor 12, 160 to rotate the rotor 12, 160 at a desired speed.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1. A drive head for a centrifuge drive that is configured to be received within a hub of a centrifuge rotor for coupling the centrifuge rotor to the centrifuge drive for rotation of the centrifuge rotor by the centrifuge drive about a rotational axis of the centrifuge drive, the hub of the centrifuge rotor having at least one drive pin for transferring rotational movement of the centrifuge drive to the centrifuge rotor, the drive head comprising:
a drive head hub including a central bore configured to receive a fastener therethrough to couple the drive head to a spindle of the centrifuge drive, the drive head hub comprising:
a plurality of recesses formed in an outer sidewall of the drive head hub and spaced circumferentially and symmetrically about the drive head hub;
a locking shoe movably retained within each of the plurality of recesses and movable therein in a radially inward direction and a radially outward direction relative to the rotational axis of the centrifuge drive; and
a resilient element located between each locking shoe and the drive head hub for biasing each locking shoe in the radially outward direction relative to the rotational axis of the centrifuge drive;
wherein each locking shoe is configured to exert a radially outwardly directed force on an interior sidewall of the hub of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

2. The drive head of claim 1, further comprising:
a crown attached to a top of the drive head hub, the crown including a central bore configured to receive the fastener therethrough and a plurality of torque slots formed in a top surface of the crown that are configured to receive the at least one drive pin of the hub of the centrifuge rotor therein to transfer rotational movement of the centrifuge drive to the centrifuge rotor; and
a retaining plate attached to a base of the drive head hub, the retaining plate including a central bore configured to receive a distal end of the spindle therethrough, and wherein each locking shoe slidably engages a base surface of the crown and a top surface of the retaining plate.

3. The drive head of claim 1, wherein each locking shoe includes a curved outer surface in transverse cross-section that matches a curvature of the interior sidewall of the hub of the centrifuge rotor in transverse cross-section, and wherein each locking shoe includes a chamfered surface that extends between the curved outer surface and a top surface of each locking shoe to facilitate insertion of the drive head into the hub of the centrifuge rotor.

4. (canceled)

5. The drive head of claim 1, wherein each locking shoe is movable between: a first position wherein each locking shoe is received within a corresponding one of the plurality of recesses in a radially inward direction relative to the rotational axis of the centrifuge drive to define a first outer diameter of the drive head hub; and
a second position wherein each locking shoe projects a distance from the corresponding one of the plurality of recesses in a radially outward direction relative to the rotational axis of the centrifuge drive to define a second outer diameter of the drive head hub that is greater than the first outer diameter.

6. The drive head of claim 1, wherein the plurality of recesses are spaced equidistantly apart about a circumference of the drive head hub to provide self-centering of the drive head within the hub of the centrifuge rotor by each locking shoe, or wherein each locking shoe includes a pair of shoulders configured to engage with abutment surfaces of each recess to prevent over-extension of the locking shoe from each recess by the resilient element.

7. (canceled)

8. (canceled)

9. The drive head of claim 2, wherein the drive head hub includes a boss that projects upwardly from a top surface of the drive head hub, the boss configured to be received within a pocket formed in a base of the crown for coupling the drive head hub to the crown, and wherein a fit between the boss of the drive head hub and the pocket of the crown is an interference fit.

10. (canceled)

11. The drive head of claim 2, wherein each torque slot is an arc-shaped blind bore, and wherein the plurality of torque slots are spaced apart circumferentially about the central bore of the crown.

12. (canceled)

13. The drive head of claim 2, wherein a first drive pin of the hub of the centrifuge rotor is configured to engage a sidewall of a first torque slot to prevent rotation of the drive head relative to the centrifuge rotor during acceleration of the centrifuge rotor by the centrifuge drive, and wherein a second drive pin of the hub of the centrifuge rotor is configured to engage a sidewall of a second torque slot to prevent rotation of the drive head relative to the centrifuge rotor during deceleration of the centrifuge rotor by the centrifuge drive.

14. (canceled)

15. A centrifuge, comprising:
the drive head of claim 1; and
a centrifuge rotor including a hub configured to receive the drive head therein, the hub including at least one drive pin that projects from an interior surface of the hub in an axially downward direction relative to the rotational axis of the centrifuge drive, the at least one drive pin configured to transfer rotational movement of the centrifuge drive to the centrifuge rotor.

16. A drive head for a centrifuge drive that is configured to be received within a hub of a centrifuge rotor for coupling the centrifuge rotor to the centrifuge drive for rotation of the centrifuge rotor by the centrifuge drive about a rotational axis of the centrifuge drive, the hub of the centrifuge rotor having at least one torque slot formed therein, the drive head comprising:
a drive head hub including a central bore configured to receive a fastener therethrough to couple the drive head to a spindle of the centrifuge drive, the drive head hub comprising:
a plurality of recesses formed in an outer sidewall of the drive head hub and spaced circumferentially and symmetrically about the drive head hub;
a locking shoe movably retained within each of the plurality of recesses and movable therein in a radially inward direction and a radially outward direction relative to the rotational axis of the centrifuge drive; and
a resilient element located between each locking shoe and the drive head hub for biasing each locking shoe in the radially outward direction relative to the rotational axis of the centrifuge drive; and
a crown attached to a top of the drive head hub, the crown including a central bore configured to receive the fastener therethrough and at least one drive pin configured to engage the at least one torque slot formed in the hub of the centrifuge rotor to transfer rotational movement of the centrifuge drive to the centrifuge rotor;
wherein each locking shoe is configured to exert a radially outwardly directed force on an interior sidewall of the hub of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

17. The drive head of claim 16, further comprising a retaining plate attached to a base of the drive head hub, the retaining plate including a central bore configured to receive a distal end of the spindle therethrough, and wherein each locking shoe slideably engages a base surface of the crown and a top surface of the retaining plate.

18. The drive head of claim 16, wherein each locking shoe includes a curved outer surface in transverse cross-section that matches a curvature of the interior sidewall of the hub of the centrifuge rotor in transverse cross-section, and wherein each locking shoe includes a chamfered surface that extends between the curved outer surface and a top surface of each locking shoe to facilitate insertion of the drive head into the hub of the centrifuge rotor.

19. (canceled)

20. The drive head of claim 16, wherein each locking shoe is movable between: a first position wherein each locking shoe is received within a corresponding
one of the plurality of recesses in a radially inward direction relative to the rotational axis of the centrifuge drive to define a first outer diameter of the drive head hub; and
a second position wherein each locking shoe projects a distance from the corresponding one of the plurality of recesses in a radially outward direction relative to the rotational axis of the centrifuge drive to define a second outer diameter of the drive head hub that is greater than the first outer diameter.

21. The drive head of claim 16, wherein the plurality of recesses are spaced equidistantly apart about a circumference of the drive head hub to provide self-centering of the drive head within the hub of the centrifuge rotor by each locking shoe.

22. (canceled)

23. The drive head of claim 16, wherein each locking shoe includes a pair of shoulders configured to engage with abutment surfaces of a corresponding one of the plurality of recesses to prevent over-extension of the locking shoe the corresponding one of the plurality of recesses, or wherein the at least one drive pin comprises a first, second, and third drive pin spaced apart circumferentially about the central bore of the crown.

24. (canceled)

25. A centrifuge, comprising:
the drive head of claim 16; and
a centrifuge rotor including a hub configured to receive the drive head therein, the hub including at least one torque slot formed therein that is configured to receive the at least one drive pin of the crown for transferring rotational movement of the centrifuge drive to the centrifuge rotor.

26. The centrifuge of claim 25, wherein each torque slot is an arc-shaped blind bore, and wherein the at least one torque slot comprises four torque slots spaced apart circumferentially about a central bore formed in the hub.

27. (canceled)

28. The drive head of claim 25, wherein a first drive pin of the crown is configured to engage a sidewall of a first torque slot to prevent rotation of the drive head relative to the centrifuge rotor during acceleration of the centrifuge rotor by the centrifuge drive, and wherein a second drive pin of the crown of the centrifuge rotor is configured to engage a sidewall of a second torque slot to prevent rotation of the drive head relative to the centrifuge rotor during deceleration of the centrifuge rotor by the centrifuge drive.

29. (canceled)

30. An adapter for mounting a drive head to a spindle of a centrifuge drive, the drive head being configured to be received within a hub of a centrifuge rotor for coupling the centrifuge rotor to the centrifuge drive for rotation of the centrifuge rotor by the centrifuge drive about a rotational axis of the centrifuge drive, the drive head including a central bore configured to receive a fastener therethrough to couple the drive head to a distal end of the spindle of the centrifuge drive, the adapter comprising:
a first projection configured to be received within a pocket formed in the drive head;
a second projection that projects in an axially opposite direction from the first projection; and
a mounting bore that extends axially through the adapter and between a first opening to the mounting bore formed in the first projection of the adapter and a second opening to the mounting formed in the second projection of the adapter;
wherein the mounting bore is configured to receive the distal end of the spindle through the second opening such that the central bore of the drive head, the mounting bore, and a threaded bore in the distal end of the spindle are coaxially arranged to receive the fastener therethrough to couple the drive head and the adapter to the distal end of the spindle of the centrifuge drive.

31. The adapter of claim 30, further comprising a cupped flange located axially between the first projection and the second projection, wherein the first projection is frustoconical in shape, or wherein the mounting bore is frustoconical in shape.

32. (canceled)

33. (canceled)
